(19) United States
(12) Patent Application Publication
(10) Pub. No.: US 2008/0284660 A1
(43) Pub. Date: Nov. 20, 2008

(54) PLANAR ANTENNA

(75) Inventor: Behzad Tavassoli Hozouri, Santa Clara, CA (US)

Correspondence Address: Patent Venture Group, 10788 Civic Center Drive, Suite 215, Rancho Cucamonga, CA, 91730-3805, US

(73) Assignee: X-ETHER, INC., Santa Clara, CA (US)

(21) Appl. No.: 12/144,765

(22) Filed: Jun. 24, 2008

Related U.S. Application Data
(60) Provisional application No. 60/948,420, filed on Jul. 6, 2007.

(51) Int. Cl. H01Q 9/04

(52) U.S. Cl. 343/700 MS

(57) ABSTRACT

A planar antenna having top and bottom nominally planar conductors that are oriented substantially planarly parallel and form an antenna interior region. The top conductor includes two radiating conductors each having an inner end and a distal end. A feed extends from outside of the planar antenna, through the antenna interior region, and to the top conductor. The feed includes a balun and has a first feed conductor that connects to the inner end of the first radiating conductor and a second feed conductor that connects to the inner end of the second radiating conductor.

### CROSS-REFERENCE TO RELATED APPLICATIONS

This application claims the benefit of U.S. Provisional Application No. 60/948,420, filed Jul. 6, 2007, hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

This invention generally relates to radio wave antennas for communications and, more specifically, to planar type antennas.

2. Background Art

The primary antenna requirements for numerous communication networks, particularly of mobile type, are compact structure, wide beam, and enough efficiency over a specific bandwidth. Cellular telephone handsets and GPS (global positional system) user equipment are examples of devices which typically have such requirements.

Another important requirement is enough isolation between the antenna and the platform to which the antenna is attached to minimize detuning of the antenna due to the presence of the platform.

The patch antenna is one type widely used when attempting to fill the above requirements. Although patch antenna have low profiles, they usually cannot provide as much isolation from the environment as is desired.

The quadrifilar helical antenna (QFH), particularly of printed type, is another typical candidate. One of the main drawbacks for QFH antennas, however, is that they often do not have low profiles and substantial miniaturization effort may then be necessary. Mass production of these antennas can also be difficult and expensive, particularly when they are loaded with a dielectric material such as ceramic.

Accordingly, there remains a need for improved antennas, particularly for mobile communications applications.

### BRIEF SUMMARY OF THE INVENTION

Accordingly, it is an object of the present invention to provide an improved planar antenna.

Briefly, one preferred embodiment of the present invention is a planar antenna. A top and bottom conductor are provided that are both nominally planar in shape and that are oriented substantially planarly parallel. The top and bottom conductor thus form an antenna interior region there between. The top conductor includes two radiating conductors that each have an inner end and a distal end. A feed extends from outside of the planar antenna, through the antenna interior region, and to the top conductor. The feed includes a balun and has a first feed conductor that connects to the inner end of the first radiating conductor and a second feed conductor that connects to the inner end of the second radiating conductor.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1a-b are perspective views of a balanced planar antenna in accord with the present invention, wherein FIG. 1a shows the planar antenna with hidden lines in ghost format and FIG. 1b shows the planar antenna without hidden lines.

FIG. 2 is a side cross-section view of the planar antenna at section A-A in FIG. 1b.

FIG. 3 is a portioned side view (equivalent to the cross-sectional view in FIG. 2) depicting an alternate embodiment of the inventive planar antenna.

In the various figures of the drawings, like references are used to denote like or similar elements or steps.

### DETAILED DESCRIPTION OF THE INVENTION

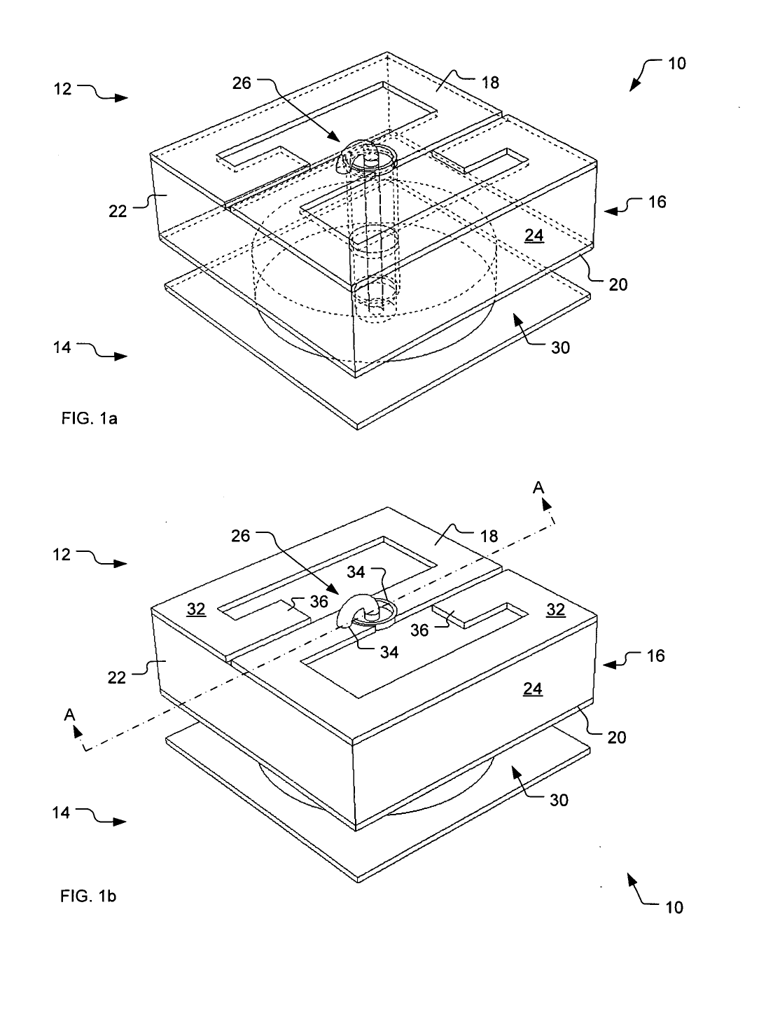

A preferred embodiment of the present invention is a planar antenna. As illustrated in the various drawings herein, and particularly in the view of FIG. 1, preferred embodiments of the invention are depicted by the general reference character 10.

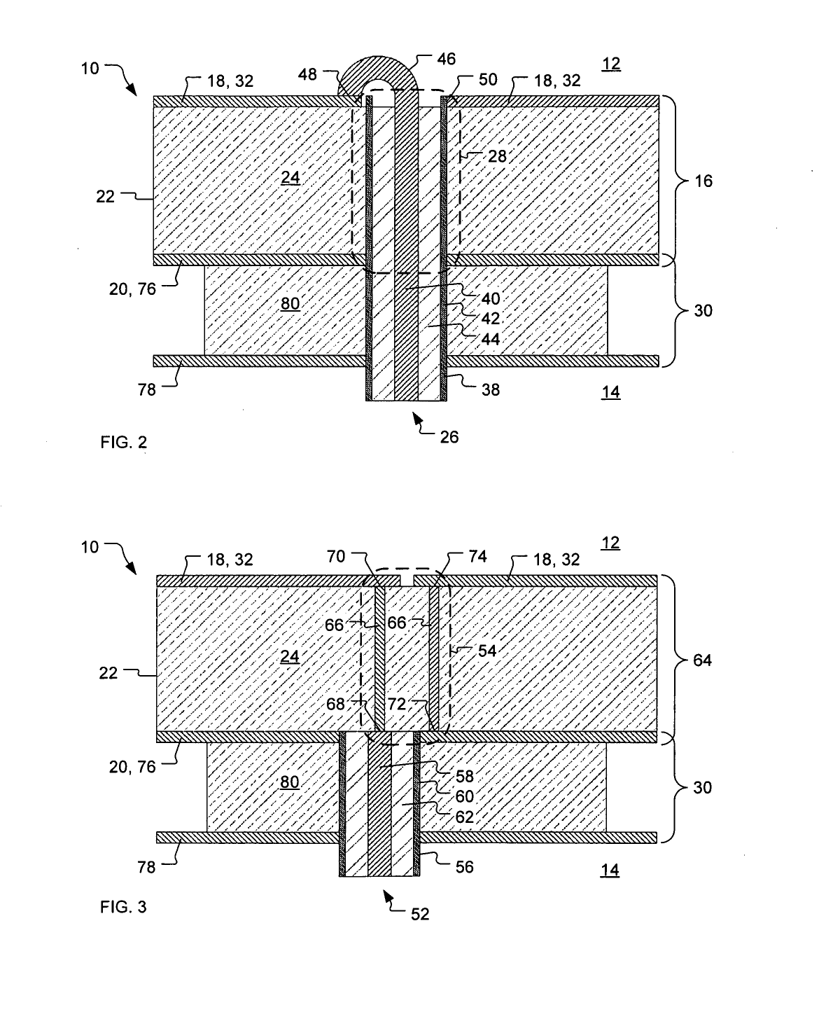

FIG. 1a-b are perspective views of a balanced planar antenna 10 in accord with the present invention, wherein FIG. 1a shows the planar antenna 10 with hidden lines in ghost format and FIG. 1b shows the planar antenna 10 without hidden lines. FIG. 2 is a side cross-section view of the planar antenna 10 at section A-A in FIG. 1b.

When oriented as shown in the figures herein, the planar antenna 10 can be described as having a defined top 12 and a defined bottom 14. The planar antenna 10 is preferably embodied having an overall shape that is either rounded or rectangular (as shown), but considerable variation is also possible. For example, rounded embodiments can resemble circular, elliptical, or other cylinders and cuboid embodiments can resemble cubes, rectangular boxes, or trapezoidal box shapes and can even have rounded comers.

The principle features of the planar antenna 10 are an antenna body 16 having a top conductor 18, a bottom conductor 20, one or more side walls 22, and an antenna interior region 24 formed there between. The planar antenna 10 further includes a feed structure 26 and a balun 28, and the planar antenna 10 may optionally include a radial choke 30 (shown in all of the figures herein).

The top conductor 18 and the bottom conductor 20 preferably are nominally planar and oriented to be substantially planarly (in respective planes) parallel to each other. The side wall 22 (or side walls 22, in the case of the square embodiment shown) may be either conductive or not. In FIGS. 1a-b and 2 the side walls 22 are merely the extents of a solid material filling the antenna interior region 24 and are not conductive.

The antenna interior region 24 may be filled with an ambient gas or vacuum, or filled with another dielectric material. In the inventors experience, the antenna interior region 24 is preferably of a material having a high dielectric constant, e.g., greater than 4.

The top conductor 18 includes two substantially similar radiating conductors 32 which are preferably spiral shaped and which each extend from a respective inner end 34 to a respective distal end 36. [Of course, the inventive planar antenna 10 can be used both for transmitting and receiving and the radiating conductors 32 emit energy when used for transmitting and absorb energy when used for receiving.]

The feed structure 26 is preferably coaxial. In the embodiment of the inventive planar antenna 10 shown in FIGS. 1a-b and 2, the feed structure 26 includes a coaxial line 38 that axially passes through the antenna body 16. This coaxial line 38 includes an inner conductor 40, an outer conductor 42, and a feed interior region 44 located there between.

The feed structure 26 is electrically connected to the top conductor 18 in any of various manners. In the embodiment shown in FIGS. 1a-b and 2, for instance, the inner conductor 40 has a hook-shaped extension 46 that connects at a feed point 48 to the inner end 34 of one radiating conductor 32, while the outer conductor 42 of the coaxial line 38 connects at a connection point 50 to the inner end 34 of the other radiating conductor 32. [FIG. 3 shows an alternate manner of electrical connection to a feed structure.]

The impedance “seen” by the feed structure 26 is not necessarily equal to its characteristic impedance, e.g., 50 Ohms, so it may be desirable to provide impedance matching in the planar antenna 10. Various conventional techniques can be used for this. On example is quarter wavelength matching. Another is the use of a matching circuit comprising a capacitance (or capacitive element) and an inductance (or inductive element) at the feed point. This can then be provided at the antenna top (for the case shown in FIGS. 1a-b and FIG. 2) or at the antenna bottom, even after a choke.

To have the planar antenna 10 be balanced the balun 28 is provided, and this can also be of various types. For example, in FIGS. 1a-b and 2 the balun 28 is similar to a sleeve type, except that the side walls 22 are not conductive.

FIG. 3 is a portioned side view (equivalent to the cross-sectional view in FIG. 2) depicting an alternate embodiment of the inventive planar antenna 10. Two noteworthy differences here are the use of an alternate feed structure 52 and an alternate balun 54.

The feed structure 52 again preferably includes a coaxial line 56 that has an inner conductor 58, an outer conductor 60, and a feed interior region 62. Instead of a coaxial line passing through the antenna body 64, however, here two conductive posts 66 pass through an appropriately modified antenna body 64.

The inner conductor 58 is electrically connected at a first juncture 68 to one post 66 that, in turn, connects to a feed point 70 at the inner end 34 of one radiating conductor 32. This post 66 can be a discrete element (as shown) or it can simply be a part of the inner conductor 58 that extends beyond the coaxial line 56 all the way to the top conductor 18. The outer conductor 60 is electrically connected at a second juncture 72 to the other post 66 that, in turn, connects to a connection point 74 at the inner end 34 of the other radiating conductor 32. The balun 54 in the embodiment of the planar antenna 10 depicted here in FIG. 3 thus is a two-wire type.

All of the figures include the optional radial choke 30. The radial choke 30 provides improved isolation between the planar antenna 10 and the environment that the planar antenna 10 is used in, The radial choke 30 also helps the balun 28, 54 to provide sufficient electrical performance. When present, the radial choke 30 includes a conductive top plate 76, a conductive bottom plate 78, and a choke interior region 80 located there between. The top plate 76 typically is the same as the bottom conductor 20 of the antenna body 16. The bottom plate 78 may by a discrete element or it may be provided by the application in which the inventive planar antenna 10 is being employed. The choke interior region 80 is preferably also filled with a dielectric material.

Various techniques and materials can be used to manufacture embodiments of the inventive planar antenna 10. For example, the top conductor 18 and the bottom conductor 20 can be made from sheet metal (e.g., copper) or can be deposited (e.g., plated, sputtered, etc.) on to a solid dielectric material in the antenna interior region 24. As already noted, the side walls 22 of the antenna body 16, 64 can be covered with a conductive layer or not. In the inventor's experience, this may particularly depend on the dielectric material filling the antenna interior region 24. If this material has a very high dielectric constant, e.g. greater than 70, then using non-conductive side walls 22 may provide better electrical performance for the balun 28, 54 or for the planar antenna 10 as a whole.

Many known miniaturization techniques can also be used in embodiments of the planar antenna 10. For example, dielectric loading and meandering the radiating conductors can be utilized to reduce antenna size. The bandwidth can also be increased using shapes for the radiating conductors (e.g., a tapered form), as is generally known in the art.

The planar antenna 10 can particularly utilize materials with high dielectric constant, e.g. greater than 4, and a balance structure to constrain the antenna near field. As the planar antenna 10 is balanced, it prevents common mode noise from entering the receiver through the antenna path. Embodiments of the planar antenna 10 therefore are highly tolerant to the proximity of people, other components and other antennas.

Using material with a high dielectric constant can also help reduce the antenna size, while maintaining high application efficiency. This also can help such embodiments have a very sharp filtering response, and hence reduce the need for any additional filtering between the planar antenna 10 and a receiver or transmitter.

While various embodiments have been described above, it should be understood that they have been presented by way of example only, and that the breadth and scope of the invention should not be limited by any of the above described exemplary embodiments, but should instead be defined only in accordance with the following claims and their equivalents.

1. A planar antenna, comprising:
a top conductor and a bottom conductor that are both nominally planar in shape and that are oriented substantially planarly parallel, wherein said top conductor and said bottom conductor form an antenna interior region there between;
said top conductor including two radiating conductors that each have an inner end and a distal end, wherein said radiating conductors are a first radiating conductor and a second radiating conductor;
a feed that extends from outside of the planar antenna, through said antenna interior region, and to said top conductor; and
said feed includes a balun and has a first feed conductor that connects to said inner end of said first radiating conductor and a second feed conductor that connects to said inner end of said second radiating conductor.

2. The antenna of claim 1, wherein said top conductor and said bottom conductor are metal plates.

3. The antenna of claim 1, wherein:
said antenna interior region is filled with a solid dielectric material; and
said top conductor and said bottom conductor are metallic depositions on said dielectric material.

4. The antenna of claim 1, wherein said top conductor and said bottom conductor are rectangular or trapizoidal, thereby causing the antenna to have a cuboid shape.

5. The antenna of claim 1, wherein said top conductor and said bottom conductor are rounded, thereby causing the antenna to have an elliptoid cylindrical shape.

6. The antenna of claim 1, wherein said antenna interior region is filled with a material having a dielectric constant greater than 4.

7. The antenna of claim 1, wherein:
said antenna interior region is filled with a solid dielectric material such that the antenna has a side wall or side walls extending between said top conductor and said bottom conductor; and
said side wall or said side walls have a conductive material.

8. The antenna of claim 7, wherein said side wall or said side walls are a metallic deposition on said dielectric material

9. The antenna of claim 1, wherein said radiating conductors have substantially similar shape and substantially equal size.

10. The antenna of claim 1, wherein said radiating conductors are spiral shaped.

11. The antenna of claim 1, wherein said first feed conductor is coaxial within said second feed conductor where said feed extends through said antenna interior region.

12. The antenna of claim 11, wherein said first feed conductor extends past said top conductor and connects to said inner end of said first radiating conductor outside a plane of said top conductor.

13. The antenna of claim 1, wherein said first feed conductor is a first balun post and said second feed conductor is a second balun post that extend through said antenna interior region.

14. The antenna of claim 1, further comprising a choke.

15. The antenna of claim 14, wherein said choke is a radial type.

16. The antenna of claim 1, wherein said choke includes a top plate that is integral with said bottom conductor of the antenna.

17. An antenna, comprising:
top planar conductive means and bottom planar conductive means that are oriented substantially planarly parallel and form an antenna interior region there between;
said top planar conductive means including two radiating conductors each having an inner end and a distal end, wherein said radiating conductors are a first radiating conductor and a second radiating conductor;
a feed means extending from outside of the antenna, through said antenna interior region, and to said top planar conductive means; and
said feed means includes a balun means and has a first feed conductor means that connects to said inner end of said first radiating conductor and a second feed conductor means that connects to said inner end of said second radiating conductor.

18. The antenna of claim 17, wherein said antenna interior region is filled with a solid dielectric means.

19. The antenna of claim 17, wherein said radiating conductors have spiral shape and substantially equal size.

20. The antenna of claim 17, further comprising a radial choke means.
